(19) United States
(12) Patent Application Publication
(10) Pub. No.: US 2023/0205142 A1
(43) Pub. Date: Jun. 29, 2023

(54) Electronic Watch

(71) Applicant: SEIKO EPSON CORPORATION, Tokyo (JP)

(72) Inventor: Yasuo NAKAJIMA, Matsumoto (JP)

(21) Appl. No.: 18/086,707

(22) Filed: Dec. 22, 2022

(30) Foreign Application Priority Data
Dec. 27, 2021 (JP) 2021-211993

(51) Int. Cl. G04C 3/00; G04C 1/06; G04C 10/02

(52) U.S. Cl. CPC G04C 3/005; G04C 1/06; G04C 10/02

(57) ABSTRACT

An electronic watch includes a case, a hand, a dial, a drive mechanism for driving the hand, a main plate to which the drive mechanism is attached, an antenna disposed between the dial and the main plate in side view when viewed from a direction parallel to a front surface of the dial, and a printed wired board, where the antenna includes a radiation electrode having a plate shape, a ground electrode having a plate shape, and a dielectric disposed between the radiation electrode and the ground electrode in the side view, the printed wired board is conducted to the radiation electrode via a power feed member, and the radiation electrode includes a portion that protrudes closer to the outside than the main plate in plan view when viewed from a direction orthogonal to the front surface of the dial.

The present application is based on, and claims priority from JP Application Serial Number 2021-211993, filed Dec. 27, 2021, the disclosure of which is hereby incorporated by reference herein in its entirety.

### BACKGROUND

### 1. Technical Field

The present disclosure relates to an electronic watch that incorporates an antenna.

### 2. Related Art

An electronic watch that incorporates an antenna for receiving a satellite signal has been known in a small electronic watch such as a wristwatch. For example, JP-A-2020-30056 discloses an electronic watch in which a flat antenna including a radiating conductor, a ground conductor, and a short-circuit portion that achieves conduction of each of the conductors is disposed between a dial and a main plate. An electronic watch that incorporates such an antenna has generally used a dedicated movement in accordance with each case size.

On the other hand, as disclosed in JP-A-2016-114552, an electronic watch that does not incorporate an antenna has been known that a plurality of types of electronic watches having different case sizes are formed at low cost by using a common movement and casing frame bodies in different sizes.

It is conceivable to form an electronic watch with a built-in antenna having a different case size by using the movement including the flat antenna disclosed in JP-A-2020-30056 and the casing frame body as disclosed in JP-A-2016-114552.

However, when a common movement is used, an antenna size is also common, and thus there is a problem that reception performance cannot be improved.

Thus, when an electronic watch with a built-in antenna having a different case size is formed, a structure that can prevent an increase in cost and can also improve reception performance is required.

### SUMMARY

An electronic watch according to the present disclosure includes a case, a hand, a dial, a drive mechanism for driving the hand, a main plate to which the drive mechanism is attached, an antenna disposed between the dial and the main plate in side view when viewed from a direction parallel to a front surface of the dial, and a printed wired board, where the antenna includes a radiation electrode having a plate shape, a ground electrode having a plate shape, and a dielectric disposed between the radiation electrode and the ground electrode in the side view, the printed wired board is conducted to the radiation electrode via a power feeding member, and the radiation electrode includes a portion that protrudes closer to the outside than the main plate in plan view when viewed from a direction orthogonal to the front surface of the dial.

An electronic watch according to the present disclosure includes a case, a hand, a dial, a drive mechanism for driving the hand, a main plate to which the drive mechanism is attached, an antenna disposed between the dial and the main plate in side view when viewed from a direction parallel to a front surface of the dial, and a printed wired board, where the main plate includes a first region to which the drive mechanism is attached, and a second region that is provided on an outer circumferential side of the first region and abuts on the case, the antenna includes a radiation electrode having a plate shape, a ground electrode having a plate shape, and a dielectric disposed between the radiation electrode and the ground electrode in the side view, the printed wired board is conducted to the radiation electrode via a power feeding member, the dial is formed in a size corresponding to the case, and the radiation electrode includes a portion that overlaps the second region in plan view when viewed from a direction orthogonal to the front surface of the dial.

### BRIEF DESCRIPTION OF THE DRAWINGS

FIG. 1 is a front view illustrating an electronic watch according to a first embodiment.

FIG. 2 is a cross-sectional view of the electronic watch according to the first embodiment.

FIG. 3 is a perspective view illustrating an antenna, a solar panel, and a printed wired board of the electronic watch according to the first embodiment.

FIG. 4 is a plan view illustrating the antenna and the solar panel of the electronic watch according to the first embodiment.

FIG. 5 is a cross-sectional view of an electronic watch according to a reference example.

FIG. 6 is a plan view illustrating the antenna and the solar panel of the electronic watch according to the reference example.

FIG. 7 is a graph illustrating a relationship between an antenna diameter and an antenna gain.

FIG. 8 is a cross-sectional view of an electronic watch according to a second embodiment.

FIG. 9 is a plan view illustrating an antenna and a solar panel according to the second embodiment.

FIG. 10 is a cross-sectional view of an electronic watch according to a third embodiment.

FIG. 11 is a plan view illustrating an antenna and a solar panel according to the third embodiment.

### DESCRIPTION OF EXEMPLARY EMBODIMENTS

### First Embodiment

An electronic watch 1 according to a first embodiment will be described below with reference to the drawings. In the present embodiment, a cover glass 15 side of the electronic watch 1 will be described as a front surface side or an upper side, and a case back 14 side will be described as a back surface side or a lower side. Further, a plan view means viewing the electronic watch 1 from a direction orthogonal to a front surface of a dial 2, that is, an axial direction of hand shafts 35 to 37, and a side view means viewing the electronic watch 1 from a direction parallel to the front surface of the dial 2.

The electronic watch 1 according to the present embodiment incorporates a planar antenna 50 described below, and is formed so as to be able to obtain satellite time information by receiving a satellite signal from position information satellites S such as a plurality of GPS satellites or quasi-zenith satellites orbiting above the earth in a predetermined trajectory, and to correct internal time information.

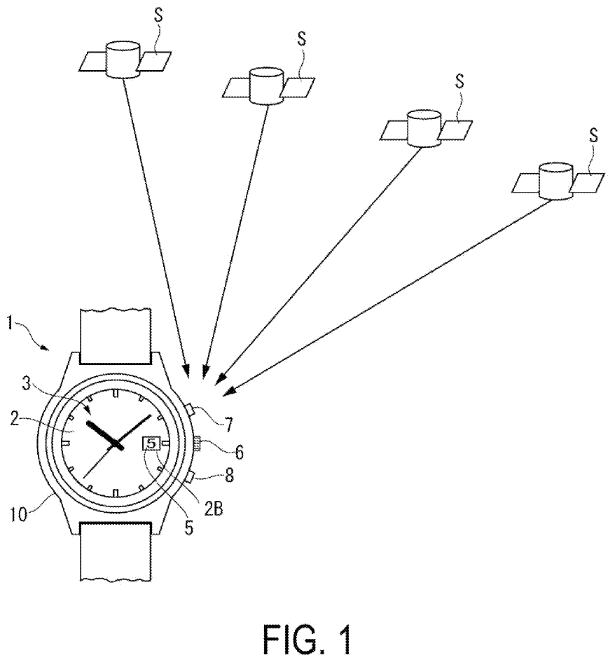

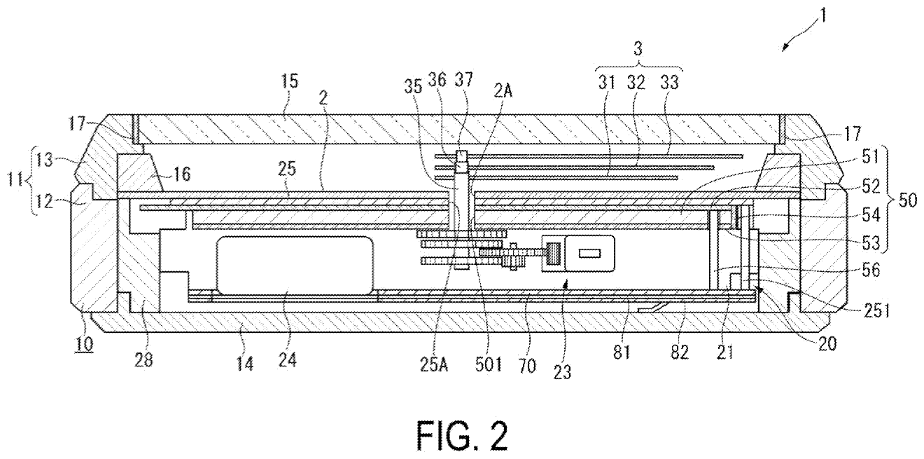

As illustrated in FIGS. 1 and 2, the electronic watch 1 includes a case 10, the dial 2 accommodated in the case 10, a hand 3, and a date indicator 5. The electronic watch 1 includes a crown 6 and two buttons 7 and 8 for an external operation.

Outer Packaging Structure of Electronic Watch

The case 10 includes a case body 11 and the case back 14. The case body 11 includes a case band 12 having a cylindrical shape, and a bezel 13 having a ring shape provided on the front surface side of the case band 12. Note that, in the present embodiment, the case band 12 and the case back 14 are formed as separate bodies, which is not limited thereto, and may be a one-piece case in which the case band 12 and the case back 14 are integrated. Further, in the present embodiment, the case band 12 and the bezel 13 are formed as separate bodies, which is not limited thereto, and a structure in which the case band 12 and the bezel 13 are integrated may be used. In this case, there is an advantage of low cost.

A material of the case band 12, the bezel 13, and the case back 14 is a metal material such as stainless steel, titanium alloy, aluminum, or brass, that is, a conductive material.

The cover glass 15 is attached to the bezel 13 via a plastic gasket 17. The cover glass 15 is formed of a transparent material such as mineral glass, sapphire glass, or organic glass.

A glass diameter being a diameter of the cover glass 15 is determined by a size of the case 10, and a thickness dimension of the cover glass 15 is determined by a relationship between the glass diameter and waterproof performance.

Internal Structure of Electronic Watch

Next, an internal structure incorporated in the case 10 of the electronic watch 1 will be described.

As illustrated in FIG. 2, the dial 2, a dial ring 16, a movement 20, and the like are accommodated inside the case 10.

The dial 2 is formed in a disk shape by a non-conductive member. The dial 2 according to the present embodiment is formed of a polycarbonate resin having a relative dielectric constant of 3. The dial 2 is formed in a size corresponding to the case 10. In other words, a planar size of the dial 2, that is, a diameter of the dial 2 in plan view is set according to an inner diameter of the case 10. In the electronic watch 1, the planar size of the dial 2 is larger than a planar size of a main plate 21 described below, and the dial 2 overlaps a part of a casing frame 28 in plan view.

As illustrated in FIG. 2, the hand 3 includes an hour hand 31, a minute hand 32, and a seconds hand 33. A through hole 2A is formed at the planar center of the dial 2, and the three hand shafts 35, 36, and 37 coaxially provided are disposed in the through hole 2A. The hour hand 31 is attached to the hand shaft 35, the minute hand 32 is attached to the hand shaft 36, and the seconds hand 33 is attached to the hand shaft 37. The hour hand 31, the minute hand 32, and the seconds hand 33 are set to a length corresponding to the planar size of the dial 2.

The hand shafts 35, 36, and 37, the hour hand 31, the minute hand 32, and the seconds hand 33 are formed of a conductive metal member.

A date window 2B having a rectangular shape is provided in the three o'clock position of the dial 2. The date indicator 5 is disposed on the back surface side of the dial 2, and the date indicator 5 is visible from the date window 2B. The hour hand 31, the minute hand 32, the seconds hand 33, and the date indicator 5 are driven via a step motor and a train wheel described below.

The dial ring 16 is formed in a ring shape in plan view by a non-conductive member similarly to the dial 2, and is disposed along an outer circumference of the dial 2. The dial ring 16 according to the present embodiment is formed of a polycarbonate resin having a relative dielectric constant of 3.

The movement 20 includes the main plate 21, a drive mechanism 23, a secondary battery 24, a solar panel 25, the planar antenna 50, a printed wired board 70, a magnetic shield plate 81, a circuit holder 82, and the like. Although not illustrated in FIG. 2, the date indicator 5 is disposed between the planar antenna 50 and the main plate 21. Further, a train wheel bridge that supports, together with the main plate 21, the train wheel constituting the drive mechanism 23 is disposed between the main plate 21 and the printed wired board 70.

The main plate 21 is formed of a synthetic resin, and a planar size of the main plate 21 is a fixed size regardless of the inner diameter of the case 10. In other words, the drive mechanism 23 is attached to a back surface of the main plate 21. Thus, the main plate 21 is formed in a size corresponding to the drive mechanism 23, that is, a size in which the drive mechanism 23 can be attached to the main plate 21. Therefore, even when the inner diameter of the case 10 increases, the planar size of the main plate 21 can be fixed. In the electronic watch 1, an outer diameter of the main plate 21 is smaller than the inner diameter of the case 10. Thus, the casing frame 28 having the ring shape is disposed in a gap between the main plate 21 and an inner surface of the case 10.

The drive mechanism 23 is attached to the back surface of the main plate 21, and drives the hour hand 31, the minute hand 32, the seconds hand 33, and the date indicator 5. In other words, the drive mechanism 23 includes four step motors that drive the hour hand 31, the minute hand 32, the seconds hand 33, and the date indicator 5, and four train wheels. The step motors are disposed in positions that do not overlap the secondary battery 24 in plan view described above.

A circuit element such as a semiconductor integrated circuit (IC), a resistor, and a capacitor is mounted at both of a front surface and a back surface of the printed wired board 70. A reception IC that processes a signal received by the planar antenna 50, and a control IC that controls driving of the hour hand 31, the minute hand 32, the seconds hand 33, and the date indicator 5 are provided as the IC. The printed wired board 70 is disposed on the back surface side of the train wheel bridge, and is formed in a size corresponding to the main plate 21, that is, a size corresponding to the drive mechanism 23.

The secondary battery 24 is a button-type lithium ion battery, and is disposed in a notch portion of the printed wired board 70.

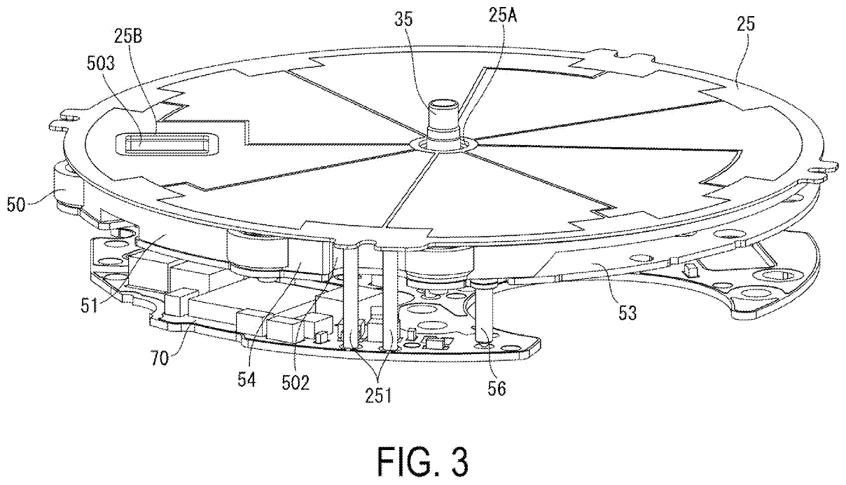

As also illustrated in FIG. 3, the solar panel 25 is a solar cell panel used for a wristwatch, and a film-type solar cell and the like having an amorphous silicon thin film stacked at a resin film substrate can be used, for example. The solar panel 25 includes a through hole 25A through which the hand shafts 35 to 37 are inserted, a date window 25B for viewing the date indicator 5, and two electrode terminals. The electrode terminals and the printed wired board 70 are conducted by two conductive members 251. Specifically, the conductive members 251 are formed of a coil spring, and a current generated by the solar panel 25 is charged to the secondary battery 24 via the conductive members 251 and the printed wired board 70.

Planar Antenna

The planar antenna 50 is an antenna that receives a satellite signal from a GPS satellite, and is formed of a plate-shaped inverted-F antenna in present embodiment.

As also illustrated in FIG. 2, the planar antenna 50 is disposed between the dial 2 and the main plate 21 in side view when viewed from the direction parallel to the front surface of the dial 2. The planar antenna 50 includes a dielectric 51, a radiation electrode 52 having a plate shape, a ground electrode 53 having a plate shape disposed so as to overlap the radiation electrode 52 in plan view, and a short-circuit portion 54 that causes a short-circuit between the radiation electrode 52 and the ground electrode 53.

A through hole 501 through which the hand shafts 35 to 37 are inserted is formed in a planar central position of the planar antenna 50. In other words, the through hole 501 is formed so as to penetrate the radiation electrode 52, the dielectric 51, and the ground electrode 53. Further, in the planar antenna 50, a date window 503 for viewing the date indicator 5 is formed in a position that overlaps the date window 2B and 25B in plan view.

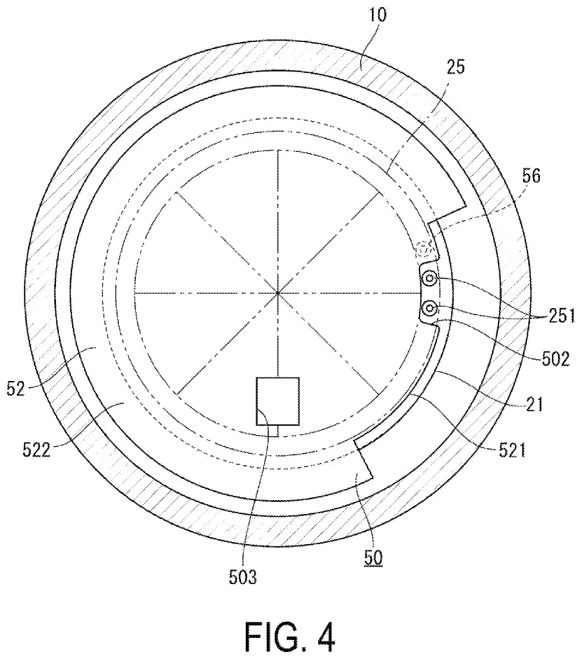

As illustrated in FIGS. 3 and 4, a recessed portion 502 is formed in an outer circumferential surface of the planar antenna 50. The conductive members 251 are disposed in the recessed portion 502. Note that FIG. 4 schematically illustrates each cell of the solar panel 25 in a fan shape acquired by dividing the solar panel 25 into eight equal parts. Further, the through hole 501 through which the hand shafts 35 to 37 are inserted is omitted from FIG. 4.

The dielectric 51 is formed of a dielectric material such as polyphenylene sulfide, a liquid crystal polymer, and polycarbonate, and is disposed between the radiation electrode 52 and the ground electrode 53 in side view.

The radiation electrode 52 is formed of a metal thin plate such as, for example, copper and iron alloy, and is conducted to the printed wired board 70 via a power feed pin 56 being a power feed member. Note that FIG. 2 schematically illustrates the power feed pin 56 such that the power feed pin 56 penetrates the ground electrode 53 and the dielectric 51 and is in contact with the radiation electrode 52. However, as illustrated in FIG. 3, the power feed pin 56 is actually formed such that a power feed terminal of the radiation electrode 52 is extended to a lower surface via a side surface of the dielectric 51, and an upper end of the power feed pin 56 is in contact with the power feed terminal.

A lower end of the power feed pin 56 abuts the printed wired board 70, and is conducted to the reception IC mounted at the printed wired board 70. Therefore, the power feed pin 56 is disposed so as to overlap the main plate 21 and the printed wired board 70 in plan view.

As illustrated in FIG. 4, at least a part of the radiation electrode 52 is formed so as to protrude closer to the outside than the main plate 21 in plan view. In other words, a part of the radiation electrode 52 provided with the recessed portion 502 is disposed inside an outer circumference of the main plate 21 in plan view, but another portion is formed so as to protrude closer to the outside than the outer circumference of the main plate 21. Therefore, the radiation electrode 52 includes the portion protruding closer to the outside than the main plate 21 in plan view.

Specifically, when a position of an outer circumference of the radiation electrode 52 in a circumferential direction is represented by a scale position of the dial 2, an outer circumferential portion 521 of the radiation electrode 52 from substantially the 11 o'clock position to substantially the two o'clock position in a clockwise direction is disposed inside the outer circumference of the main plate 21. In other words, a dimension from central axes of the hand shafts 35 to 37 to the outer circumferential portion 521 is set smaller than a dimension from the central axes of the hand shafts 35 to 37 to the outer circumference of the main plate 21.

Meanwhile, an outer circumferential portion 522 of the radiation electrode 52 from substantially the two o'clock position to substantially the 11 o'clock position in the clockwise direction protrudes closer to the outside, that is, the case 10 side than the outer circumference of the main plate 21. In other words, a dimension from the central axes of the hand shafts 35 to 37 to the outer circumferential portion 522 is set greater than a dimension from the central axes of the hand shafts 35 to 37 to the outer circumference of the main plate 21. Thus, the casing frame 28 disposed outside the main plate 21 overlaps the radiation electrode 52 in plan view.

As also illustrated in FIG. 2, the dielectric 51 and the ground electrode 53 of the planar antenna 50 are formed to be smaller than the main plate 21. Thus, an outer circumference of the dielectric 51 and the ground electrode 53 is disposed inside the outer circumference of the main plate 21.

Therefore, an area of the radiation electrode 52 is set greater than that of the dielectric 51 and the ground electrode 53 in plan view, and is further set greater than an area of the solar panel 25.

The ground electrode 53 is formed of a metal thin plate such as, for example, copper and iron alloy, and is conducted to a ground terminal of the printed wired board 70. Note that the ground electrode 53 is formed in a size such that a front surface of the main plate 21 is mostly covered, and thus also serves as a magnetic shield plate that covers the dial 2 side of the step motor. Further, the radiation electrode 52 is the metal plate as described above, and thus also serves as a support substrate that supports the solar panel 25 formed of a film.

The short-circuit portion 54 is formed of a metal coating formed of plating and the like at a side surface of a metal thin plate or the dielectric 51, and is conducted to the radiation electrode 52 and the ground electrode 53. The short-circuit portion 54 is provided in at least the recessed portion 502, and is also provided in the outer circumferential portion 521 in the present embodiment. Thus, the conductive members 251 are disposed on an outer circumference side of the short-circuit portion 54. Further, the outer circumferential portion 522 of the radiation electrode 52 protruding closer to the outside than the main plate 21 is a portion other than a portion in which the short-circuit portion 54 is provided.

### Reference Example

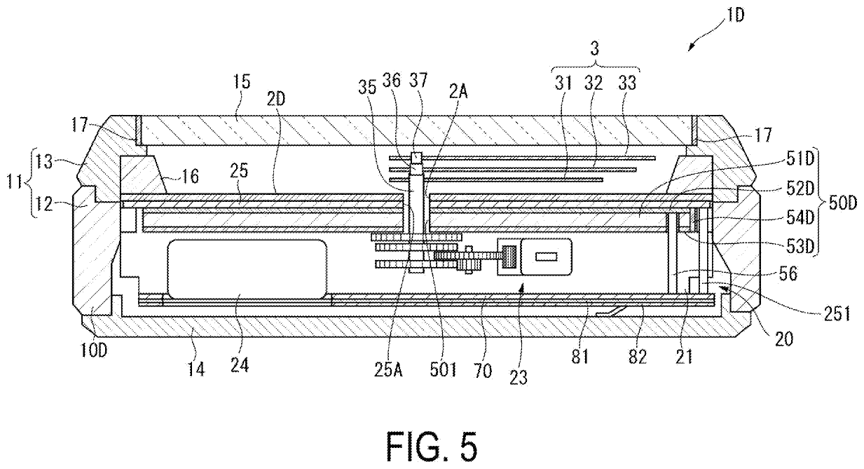

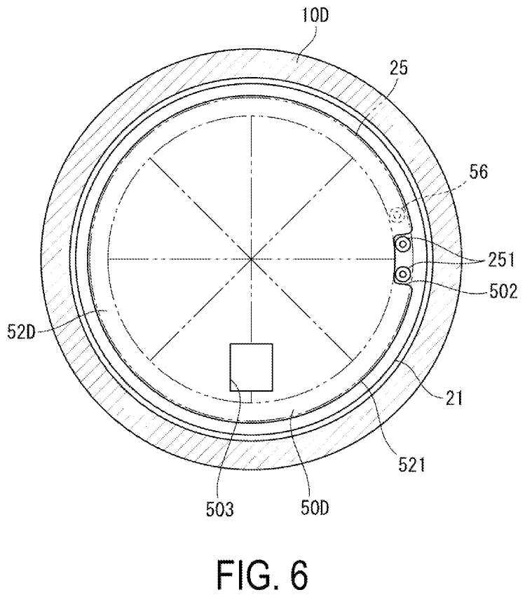

For a comparison with the electronic watch 1 according to the present embodiment, an electronic watch 1D in which the case 10 has a size smaller than that in the electronic watch 1 will be described with reference to FIGS. 5 and 6. Note that configurations of the electronic watch 1D identical to or similar to those of the electronic watch 1 will be denoted by the same reference signs and descriptions will be omitted.

In the electronic watch 1D, a case 10D has a planar size smaller than that in the electronic watch 1. Specifically, an inner surface size of the case 10D is set in accordance with the planar size of the main plate 21, and the main plate 21 is disposed inside the case 10D without providing the casing frame 28. In other words, the electronic watch 1D is a watch having a minimum size in which the main plate 21 can be disposed.

Further, a planar antenna 50D of the electronic watch 1D includes a dielectric 51D, a radiation electrode 52D, a ground electrode 53D, and a short-circuit portion 54D. The dielectric 51D, the ground electrode 53D, and the short-circuit portion 54D have a configuration similar to that of the dielectric 51, the ground electrode 53, and the short-circuit portion 54 of the electronic watch 1.

The electronic watch 1D is different from the electronic watch 1 in a point that a dial 2D has a planar size smaller than that of the dial 2 of the electronic watch 1 in accordance with the size of the case 10D, in a point that a length of the hour hand 31, the minute hand 32, and the seconds hand 33 is shorter than that in the electronic watch 1 in accordance with the dial 2D, and in a point that the radiation electrode 52D has a planar size smaller than that of the radiation electrode 52 of the electronic watch 1. As illustrated in FIG. 6, the radiation electrode 52D has the planar size smaller than that of the main plate 21, and an outer circumferential portion 521D of the radiation electrode 52D is disposed inside an outer circumferential surface of the main plate 21 across the entire circumference.

In the electronic watch 1D, the other configurations are similar to those of the electronic watch 1, and thus descriptions will be omitted. Further, an arrangement position of the conductive members 251 and the power feed pin 56 in plan view are common in the electronic watches 1 and 1D. A planar size of the date indicator 5 is restricted to a size in which the date indicator 5 does not interfere with the conductive members 251 and the power feed pin 56. Thus, a size of the date indicator 5 and a formation position of the date windows 2B, 25B, and 503 are common in the electronic watches 1 and 1D.

Improvement Effect of Antenna Gain

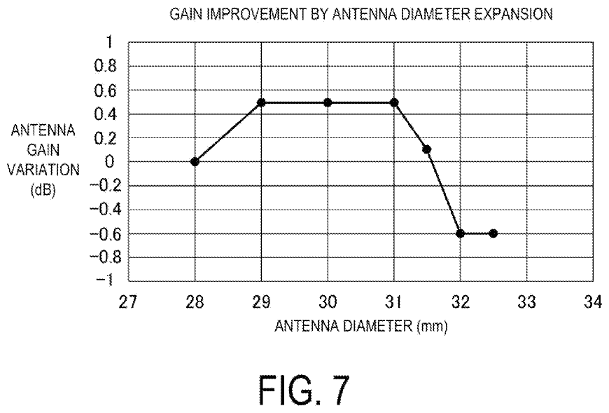

FIG. 7 is a graph illustrating an improvement effect of an antenna gain when an antenna diameter of the planar antenna 50, specifically, a diameter of the radiation electrode 52 is expanded. FIG. 7 illustrates a gain variation when the inner diameter of the case 10 is set to be 33 mm, and the antenna diameter is expanded with, as a reference (0 dB), the antenna gain in a case of the antenna diameter of the planar antenna 50 of 28 mm. As illustrated in FIG. 7, when the antenna diameter is expanded by 1 to 3 mm, the antenna gain is improved by approximately 0.5 dB. However, when the antenna diameter is further expanded, the antenna gain decreases. Particularly when a difference between the inner diameter of the case 10 and the antenna diameter is equal to or less than 1 mm, the antenna gain decreases further than that when the antenna diameter is 28 mm. The reason is that the planar antenna 50 is too close to the case 10 formed of metal, and reception sensitivity decreases.

Therefore, it can be confirmed that the reception sensitivity is improved by appropriately expanding the size of the planar antenna 50 in accordance with the inner diameter of the case 10.

Effects of First Embodiment

According to the present embodiment, in the electronic watch 1 including the case 10 having a large planar size, the movement 20 other than the dial 2 and the radiation electrode 52 is common to that of the electronic watch 1D including the case 10D having a small planar size, and thus a manufacturing cost of the electronic watches 1 and 1D having different case sizes can be reduced. In other words, in the electronic watches 1 and 1D, the main plate 21, the drive mechanism 23, the printed wired board 70, and the like can be used in common, and when incorporated into the case 10 having a large size with respect to the main plate 21, the dial 2, the radiation electrode 52, and the casing frame 28 that correspond to a case size may be selected and used. Thus, when the electronic watches 1 and 1D having different sizes of the dials 2 and 2D and the cases 10 and 10D are formed, the common movement 20 can be used, and an increase in cost can be prevented.

In the electronic watch 1, the planar size of the radiation electrode 52 of the planar antenna 50 is increased in accordance with the size of the case 10, and thus the reception sensitivity of the planar antenna 50 can be improved.

In the planar antenna 50 of the electronic watch 1, only the size of the radiation electrode 52 is increased, and the dielectric 51 and the ground electrode 53 are common to those of the planar antenna 50D of the electronic watch 1D. Thus, an increase in cost of the planar antenna 50 can be suppressed to a minimum, and the reception sensitivity can also be improved.

In the radiation electrode 52, the recessed portion 502 and the outer circumferential portion 521 provided with the short-circuit portion 54 are not expanded, and the outer circumferential portion 522 other than the recessed portion 502 and the outer circumferential portion 521 is expanded outward, and thus the arrangement position of the power feed pin 56 and the conductive members 251 can be made common in the planar antennas 50 and 50D. Thus, the same printed wired board 70 including a terminal position in which the power feed pin 56 and the conductive members 251 are in contact can be used, and a cost can be reduced since it is not necessary to change the printed wired board 70 in accordance with the case size.

Furthermore, since the conductive members 251 are disposed in the recessed portion 502 in which the short-circuit portion 54 is formed, that is, the outside of the short-circuit portion 54, an influence of the conductive members 251 formed of the coil spring on the reception sensitivity can be reduced.

### Second Embodiment

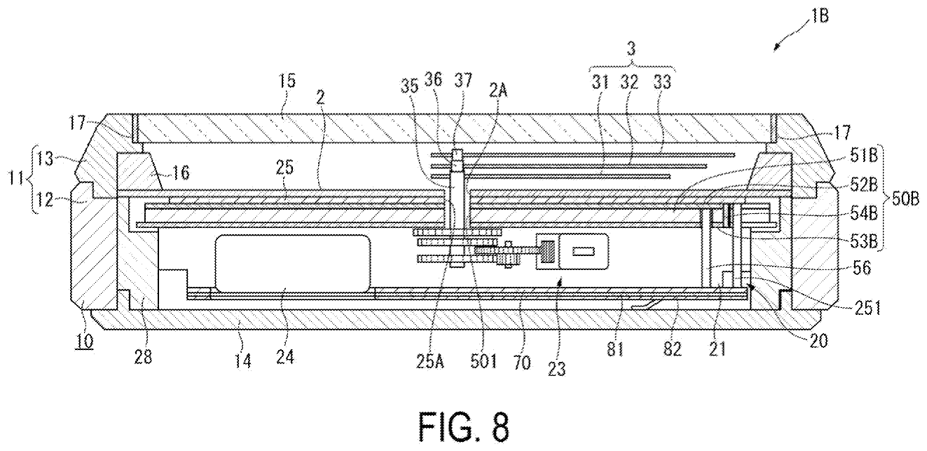

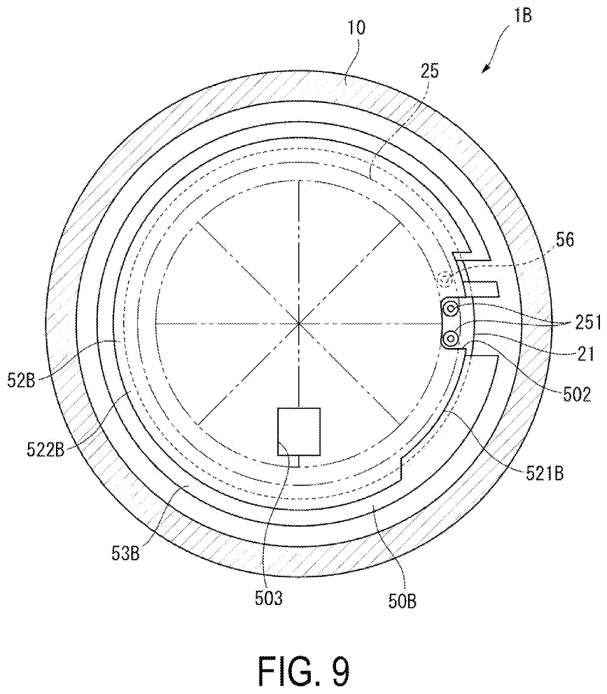

Next, an electronic watch 1B according to a second embodiment will be described with reference to FIGS. 8 and 9.

The electronic watch 1B is different from the electronic watch 1 according to the first embodiment in a configuration of a planar antenna 50B, and the other configurations are common. Therefore, the configurations common to those of the electronic watch 1 according to the first embodiment will be denoted by the same reference signs and descriptions will be omitted.

As illustrated in FIGS. 8 and 9, the planar antenna 50B of the electronic watch 1B includes a radiation electrode 52B, a dielectric 51B, a ground electrode 53B, and a short-circuit portion 54B.

The dielectric 51B also serves as a date indicator maintaining plate that holds a date indicator (not illustrated). The radiation electrode 52B is formed of a metal coating formed on a front surface side of the dielectric 51B. Further, the short-circuit portion 54B is formed of a metal coating formed at a side surface and a back surface of the dielectric 51B. For example, the metal coating can be formed by plating processing such as copper, silver, nickel, and aluminum, and the like.

Therefore, the dielectric 51B and the radiation electrode 52B have the same size in plan view, and are further formed in a planar size larger than that of a solar panel 25 in the present embodiment. Further, the dielectric 51B and the radiation electrode 52B include an outer circumferential portion 521B having an outer circumferential surface located inside an outer circumference of a main plate 21, and an outer circumferential portion 522B located outside the main plate 21. An area of the radiation electrode 52B is larger than that of the radiation electrode 52D of the planar antenna 50D by providing the outer circumferential portion 522B.

The ground electrode 53B is formed of a metal plate material, and is formed in a planar size larger than that of the dielectric 51B and the radiation electrode 52B. Thus, in the planar antenna 50B, in addition to the radiation electrode 52B, at least a part of the dielectric 51B and the ground electrode 53B also protrudes closer to the outside than the main plate 21 in plan view. In other words, the radiation electrode 52B, the dielectric 51B, and the ground electrode 53B of the planar antenna 50B each include the portion protruding closer to the outside than the main plate 21 in plan view.

Further, the ground electrode 53B is formed in a size such that a dial 2 side of a drive mechanism 23 is mostly covered, and thus also serves as a magnetic shield plate.

The short-circuit portion 54B is conducted to the radiation electrode 52B, and is further in contact with the ground electrode 53B to be also conducted to the ground electrode 53B. The short-circuit portion 54B is formed in portions of the outer circumferential portion 521B and a recessed portion 502.

Therefore, the outer circumferential portion 522B in the radiation electrode 52B and the dielectric 51B protruding closer to the outside than the main plate 21 is a portion other than the outer circumferential portion 521B provided with the short-circuit portion 54B. Meanwhile, the ground electrode 53B other than the recessed portion 502 in which conductive members 251 are disposed protrudes closer to the outside than the main plate 21. The portions protruding closer to the outside than the main plate 21 overlap a casing frame 28 in plan view.

The radiation electrode 52B is conducted to a printed wired board 70 via a power feed pin 56. Note that FIG. 8 schematically describes a conduction structure between the power feed pin 56 and the radiation electrode 52B. However, in the planar antenna 50B, a power feed terminal is formed by forming a metal coating that reaches from the radiation electrode 52B to the back surface via the side surface of the dielectric 51B, and the power feed pin 56 abuts on the power feed terminal provided at the back surface of the dielectric 51B to achieve conduction. A planar arrangement position of the power feed pin 56 and the conductive members 251, that is, an arrangement position of the power feed pin 56 and the conductive members 251 with respect to central axes of hand shafts 35 to 37 in plan view is the same as that in the electronic watches 1 and 1D. Thus, the same date indicator 5 and the same printed wired board 70 as those in the electronic watches 1 and 1D are also used in the electronic watch 1B. Further, the conductive members 251 disposed in the recessed portion 502 are disposed outside the short-circuit portion 54B.

Effects of Second Embodiment

In the electronic watch 1B according to the second embodiment, the area of the dielectric 51B and the radiation electrode 52B of the planar antenna 50B is larger than that of the planar antenna 50D, and the ground electrode 53B is further formed larger than the radiation electrode 52B, and thus reception sensitivity of the planar antenna 50B can be further improved.

Since the main plate 21, the driving mechanism 23, a secondary battery 24, the solar panel 25, the casing frame 28, the power feed pin 56, the printed wired board 70, a magnetic shield plate 81, a circuit holder 82, and the conductive members 251 are common to those of the electronic watch 1 according to the first embodiment and the electronic watch 1D, a cost can be reduced. In other words, the electronic watches 1, 1B, and 1D having different case sizes and different antenna performance can be manufactured while preventing an increase in cost.

### Third Embodiment

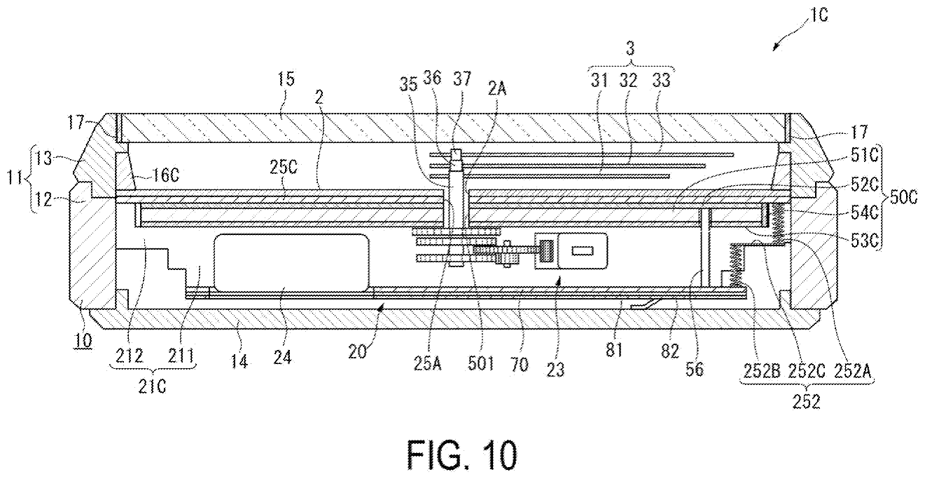

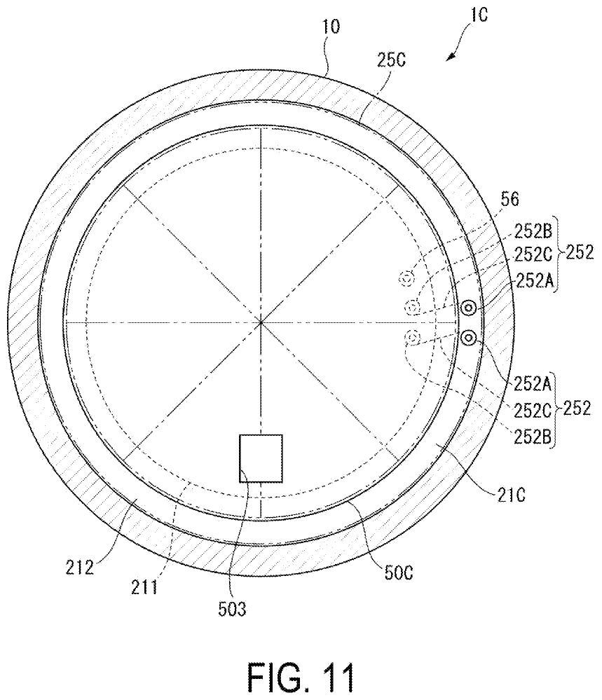

Next, an electronic watch 1C according to a third embodiment will be described with reference to FIGS. 10 and 11.

The electronic watch 1C is different from the electronic watch 1 in configurations of a planar antenna 50C, a solar panel 25C, a conductive member 252, a main plate 21C, and a dial ring 16C, and the other configurations are common. Therefore, the configurations common to those of the electronic watch 1 according to the first embodiment will be denoted by the same reference signs and descriptions will be omitted.

The planar antenna 50C of the electronic watch 1C includes a dielectric 51C, a radiation electrode 52C, a ground electrode 53C, and a short-circuit portion 54C.

The dielectric 51C also serves as a date indicator maintaining plate that holds a date indicator (not illustrated). The radiation electrode 52C is formed of a metal coating formed on a front surface side of the dielectric 51C, the ground electrode 53C is formed of a metal coating formed on a back surface side of the dielectric 51C, and the short-circuit portion 54C is formed of a metal coating formed at a side surface of the dielectric 51C. For example, the metal coating can be formed by plating processing such as copper, silver, nickel, and aluminum, and the like. Therefore, the dielectric 51C, the radiation electrode 52C, and the ground electrode 53C have the same size in plan view.

Further, the main plate 21C of the electronic watch 1C includes a first region 211 to which a drive mechanism 23 is attached, and a second region 212 formed on an outer circumference side of the first region 211 and formed in a dimension according to a difference between an inner diameter of a case 10 and a planar size of the first region 211. The first region 211 is formed in the same planar size as the main plate 21 that can be incorporated into the case 10D having the smallest size. A width dimension of the second region 212, that is, a protrusion dimension from the first region 211 to the outer circumferential surface of the second region 212 is set in accordance with a case size. Thus, the second region 212 of the main plate 21C can abut on an inner surface of the case 10, and the main plate 21C can be directly accommodated inside the case 10 without providing a casing frame. Note that the second region 212 may abut on the inner surface of the case 10 across the entire circumference, or may abut on the inner surface of the case 10 at a plurality of places.

The solar panel 25C has an area larger than that of the solar panel 25 of the electronic watches 1 and 1B. Note that a power generation layer of the solar panel 25C is set so as to have an area smaller than that of the radiation electrode 52C of the planar antenna 50C, and a portion without the power generation layer of the solar panel 25 being provided is expanded. Furthermore, the dial ring 16C is a member having an area that covers a dial 2 and the solar panel 25C smaller than that of the dial ring 16.

The conductive member 252 includes a first coil spring 252A in contact with a terminal of the solar panel 25C, a second coil spring 252B in contact with a terminal of a printed wired board 70, and a coupling portion 252C that couples the first coil spring 252A and the second coil spring 252B. The second coil spring 252B is disposed in the first region 211 of the main plate 21C, and the first coil spring 252A and the coupling portion 252C are disposed in the second region 212 of the main plate 21C. Further, the first coil spring 252A is disposed outside the short-circuit portion 54C.

Since the first coil spring 252A of the conductive member 252 is disposed outside the second coil spring 252B, a diameter of a date indicator 5 can be increased and a date window 503 can be disposed closer to an outer circumference side as compared to the electronic watches 1 and 1B. At this time, only a width dimension of the date indicator 5 is increased, and a position of inner teeth and a date indicator driving wheel of the date indicator 5 is common to that in the electronic watches 1 and 1B.

Further, since the first coil spring 252A is disposed on the outside, it is not necessary to form, in the planar antenna 50C, a recessed portion in which the conductive member 252 is disposed. Thus, an outer circumferential portion of the planar antenna 50C is expanded to a position that overlaps the second region 212 of the main plate 21C across the entire circumference.

Effects of Third Embodiment

In the electronic watch 1C according to the third embodiment, not only the area of the planar antenna 50C is expanded, but also the area of the solar panel 25C is increased, and thus reception sensitivity and power generation capacity can be improved.

Further, since the driving mechanism 23, a secondary battery 24, a power feed pin 56, the printed wired board 70, a magnetic shield plate 81, and a circuit holder 82 are common to those of the electronic watches 1, 1B, and 1D, a cost can be reduced. Further, a holding shape of the drive mechanism 23 in the first region 211 of the main plate 21C can be formed in common with the electronic watches 1, 1B, and 1D, and only the second region 212 may be changed in accordance with the case size. In other words, the electronic watches 1, 1B, 1C, and 1D having different case sizes and different antenna performance can be manufactured while preventing an increase in cost.

Since the first coil spring 252A of the conductive member 252 is disposed outside the second coil spring 252B, a diameter of the date indicator 5 can be increased and the date window 503 can be expanded closer to the outer circumference side. In this case, only a width dimension of the date indicator 5 is increased, and thus it is not necessary to change the position of the inner teeth and the date indicator driving wheel of the date indicator 5, and an increase in cost can be suppressed.

Since the first coil spring 252A is disposed on an outer circumference side of the solar panel 25C, a coupling portion between the first coil spring 252A and the solar panel 25C can be covered with the dial ring 16C. Thus, an appearance of the electronic watch 1C can be improved.

### Other Embodiments

Note that the present disclosure is not limited to each of the embodiments described above, and various variations can be made within the scope of the gist of the present disclosure.

For example, a shape of a planar antenna is not limited to a substantially circular antenna in plan view, and may be a square shape or a tonneau type in plan view. For example, in an electronic watch that uses a case having a square or tonneau-type planar shape, a shape of a dial, a solar panel, and a planar antenna may be square or a tonneau type in accordance with a shape of the case, and the other configurations such as the main plate 21 and the drive mechanism 23 may be made common in the electronic watches 1, 1B, and 1C according to each of the embodiments described above. Note that a casing frame may be used in order to incorporate a circular main plate 21 into a case having a square shape or the like.

The planar antennas 50, 50B, and 50C are not limited to a plate-shaped inverted-F antenna that resonates in one quarter-wavelength of a received signal, and another antenna such as a thin patch antenna that resonates in one half-wavelength of a received signal may be used.

The dielectrics 51, 51B, and 51C of the planar antennas 50, 50B, and 50C are not limited to those that also serve as a date indicator maintaining component, and may have a function of holding another watch part, or may be provided specially for the antenna.

In the planar antennas 50 and 50B, the outer circumferential portions 522 and 522B other than the short-circuit portions 54 and 54B protrude outside the main plate 21, but a portion other than the recessed portion 502, that is, other than a portion of the short-circuit portions 54 and 54B facing the conductive members 251 and 252 may also protrude outside the main plate 21.

The solar panel 25 of the electronic watches 1 and 1B has the same size as that of the solar panel 25 of the electronic watch 1D having a small case size, but a solar panel having a larger area may be used in accordance with an expanded case size. At this time, a power generation layer of the solar panel 25 may have an area smaller than that of the radiation electrodes 52 and 52B of the planar antenna 50, and may have an expanded portion without the power generation layer being provided. In this case, an arrangement position of the conductive members 251 is not changed, and thus an area may be increased by expanding an outer circumference side of the solar panel in a range that overlaps the outer circumferential portions 522 and 522B, instead of expanding the solar panel in a range that overlaps the outer circumferential portions 521 and 521B including the recessed portion 502 provided with the short-circuit portions 54 and 54B.

The electronic watches 1, 1B, and 1C according to the embodiments described above are a three-hand watch including the hour hand 31, the minute hand 32, and the seconds hand 33, but a shape, a through hole, and the like in which other motor, train wheel, and hand shaft can be disposed may be provided in advance in the main plates 21 and 21C and the planar antennas 50, 50B, and 50C. Such a configuration can easily achieve presence or absence of a subdial, modifications of a position of the subdial, and the like by addition of corresponding motor and train wheel and modifications of a dial. Thus, in addition to modifications of a case size, a derivative development of an electronic watch such as addition of a display can be easily achieved.

Furthermore, a material of the case 10 is not limited to metal. For example, the case body 11 including the case band 12 and the bezel 13, and the case back 14 may be formed of ceramic or a synthetic resin.

An electronic watch may use a primary battery instead of the secondary battery 24 without including the solar panels 25 and 25C. In this case, the conductive members 251 and 252 are not required, and the conductive members 251 and 252 do not affect the reception sensitivity of the planar antennas 50, 50B, and 50C, and thus an arrangement position of the short-circuit portions 54, 54B, and 54C can be changed.

The short-circuit portions 54, 54B, and 54C are provided for an adjustment of reception characteristics of the planar antennas 50, 50B, and 50C, and thus a short-circuit portion may not be provided when a signal can be received without the short-circuit portions 54, 54B, and 54C.

In each of the embodiments described above, the antenna receives a satellite signal transmitted from a GPS satellite, but a signal received by the antenna is not limited to a satellite signal. For example, a satellite signal transmitted from each satellite such as another global navigation satellite system (GNSS) such as Galileo, GLONASS, and Beidou, a satellite-based augmentation system (SBAS), and a regional navigation satellite system (RNSS) such as a quasi-zenith satellite that can perform a search only in a specific region may be received.

The antenna is not limited to an antenna that receives a satellite signal, and may be an antenna that receives other radio waves such as, for example, Bluetooth (registered trademark), Bluetooth Low Energy (BLE), Wi-Fi (registered trademark), Near Field Communication (NFC), and Low Power Wide Area (LPWA). In other words, an appropriate antenna incorporated into the electronic watches 1, 1B, and 1C may be used according to a type of a received signal, a size of the watch, a fit with other components, and the like.

### SUMMARY OF PRESENT DISCLOSURE

An electronic watch according to the present disclosure includes a case, a hand, a dial, a drive mechanism for driving the hand, a main plate to which the drive mechanism is attached, an antenna disposed between the dial and the main plate in side view when viewed from a direction parallel to a front surface of the dial, and a printed wired board, wherein the antenna includes a radiation electrode having a plate shape, a ground electrode having a plate shape, and a dielectric disposed between the radiation electrode and the ground electrode in the side view, the printed wired board is conducted to the radiation electrode via a power feed member, and the radiation electrode includes a portion that protrudes closer to the outside than the main plate in plan view when viewed from a direction orthogonal to the front surface of the dial.

According to the electronic watch of the present disclosure, the antenna is disposed between the dial and the main plate in the side view, and thus an area of the antenna can be increased. Furthermore, the radiation electrode includes the portion protruding closer to the outside than the main plate in the plan view, and thus an area of the radiation electrode can be increased. Thus, a size of the radiation electrode can be increased in accordance with a case size, and reception sensitivity of the antenna can be improved.

In the electronic watch according to the present disclosure, the ground electrode and the dielectric may include a portion protruding closer to the outside than the main plate in the plan view.

In addition to the radiation electrode, an area of the ground electrode and the dielectric can also be increased, and thus the reception sensitivity of the antenna can be further improved.

The electronic watch according to the present disclosure includes a solar panel, and a conductive member configured to achieve conduction between the solar panel and the printed wired board, wherein the antenna may include a short-circuit portion configured to cause a short-circuit between the radiation electrode and the ground electrode, the conductive member and the short-circuit portion may overlap the main plate in the plan view, and the conductive member may be disposed outside the short-circuit portion in the plan view.

Antenna characteristics can be easily adjusted by providing the short-circuit portion that causes a short-circuit between the radiation electrode and the ground electrode. Further, the conductive member is disposed in a position that overlaps the main plate in the plan view, and can thus be conducted to the printed wired board in the position that overlaps the main plate in the plan view, and the printed wired board can also be made common.

Furthermore, the conductive member is disposed outside the short-circuit portion, and thus an influence of the conductive member formed of a coil spring and the like on the reception sensitivity of the antenna can be reduced.

In the electronic watch according to the present disclosure, the antenna may include a short-circuit portion configured to cause a short-circuit between the radiation electrode and the ground electrode, and a portion of the radiation electrode protruding closer to the outside than the main plate may be a portion other than the short-circuit portion.

In the radiation electrode of the antenna, the portion protruding closer to the outside than the main plate is set to be the portion other than the short-circuit portion, and thus a portion having a large area other than the short-circuit portion can protrude, the area of the radiation electrode can be effectively increased, and the reception sensitivity of the antenna can be improved. Further, the short-circuit portion does not protrude closer to the outside than the main plate, and thus, when a coupling member is disposed outside the short-circuit portion, an arrangement position of the coupling member can be fixed, and the printed wired board and the like can be made common.

In the electronic watch according to the present disclosure, a portion of the radiation electrode protruding closer to the outside than the main plate may be a portion other than a portion of the short-circuit portion facing the conductive member.

In the radiation electrode of the antenna, the portion protruding closer to the outside than the main plate is set to be the portion other than the portion of the short-circuit portion facing the conductive member. Thus, a portion having a large area other than the portion including the portion of the short-circuit portion facing the conductive member in addition to the short-circuit portion can protrude, the area of the radiation electrode can be effectively increased, and the reception sensitivity of the antenna can be improved. Further, the portion of the short-circuit portion facing the conductive member does not protrude closer to the outside than the main plate, and thus an arrangement position of the coupling member can be fixed, and the printed wired board and the like can be made common.

The electronic watch according to the present disclosure includes a casing frame disposed between the case and the main plate, wherein the casing frame may overlap the radiation electrode in the plan view.

A common main plate can be attached to cases having various sizes by using a casing frame in accordance with a case size. Further, the radiation electrode can be expanded to a position of the casing frame, and thus the size of the radiation electrode can be increased in accordance with the case size, and the reception performance can be improved.

In the electronic watch according to the present disclosure, the printed wired board may be formed in a size corresponding to the drive mechanism, and the power feed member may overlap the main plate and the printed wired board in the plan view.

The printed wired board is formed in the size corresponding to the drive mechanism, and can thus be set to a minimum size similarly to the main plate. Thus, a common printed wired board can be used together with the main plate and the drive mechanism for a plurality of types of cases having different sizes, and an increase in cost can be prevented.

Furthermore, the power feed member that achieves conduction between the antenna and the printed wired board overlaps the main plate and the printed wired board in the plan view, and thus an arrangement position of the power feed member can be fixed regardless of the case size, and the printed wired board can also be common in this regard.

An electronic watch according to the present disclosure includes a case, a hand, a dial, a drive mechanism for driving the hand, a main plate to which the drive mechanism is attached, an antenna disposed between the dial and the main plate in side view when viewed from a direction parallel to a front surface of the dial, and a printed wired board, wherein the main plate includes a first region to which the drive mechanism is attached, and a second region that is provided on an outer circumferential side of the first region and abuts on the case, the antenna includes a radiation electrode having a plate shape, a ground electrode having a plate shape, and a dielectric disposed between the radiation electrode and the ground electrode in the side view, the printed wired board is conducted to the radiation electrode via a power feed member, the dial is formed in a size corresponding to the case, and the radiation electrode includes a portion that overlaps the second region in plan view when viewed from a direction orthogonal to the front surface of the dial.

According to the electronic watch of the present disclosure, the main plate includes the first region to which the drive mechanism is attached, and the second region that abuts on the case. Thus, a main plate having a different dimension of the second region, and a dial having a size corresponding to the case may be used for a plurality of types of cases having different sizes, the other component such as the drive mechanism can be made common, and an increase in cost can be prevented.

Further, the antenna is disposed between the dial and the main plate in the side view, and thus an area of the antenna can be increased. Furthermore, the radiation electrode includes the portion that overlaps the second region of the main plate in the plan view, and thus an area of the radiation electrode can be further increased. Thus, a size of the radiation electrode can be increased in accordance with a case size, and reception sensitivity of the antenna can be improved.

What is claimed is:

1. An electronic watch, comprising:
a case;
a hand;
a dial;
a drive mechanism configured to drive the hand;
a main plate to which the drive mechanism is attached;
an antenna disposed between the dial and the main plate in side view when viewed from a direction parallel to a front surface of the dial; and
a printed wired board, wherein
the antenna includes
a radiation electrode having a plate shape,
a ground electrode having a plate shape, and
a dielectric disposed between the radiation electrode and the ground electrode in the side view,
the printed wired board is conducted to the radiation electrode via a power feed member, and
the radiation electrode includes a portion that protrudes outward from the main plate in plan view when viewed from a direction orthogonal to the front surface of the dial.

2. The electronic watch according to claim 1, wherein
the ground electrode and the dielectric include a portion that protrudes outward from the main plate in the plan view.

3. The electronic watch according to claim 1, comprising:
a solar panel; and
a conductive member configured to conduct between the solar panel and the printed wired board, wherein
the antenna includes a short-circuit portion configured to short-cut between the radiation electrode and the ground electrode,
the conductive member and the short-circuit portion overlap the main plate in the plan view, and
the conductive member is disposed outside the short-circuit portion in the plan view.

4. The electronic watch according to claim 1, wherein
the antenna includes a short-circuit portion configured to short-circuit between the radiation electrode and the ground electrode, and
a portion protruding outward from the main plate in the radiation electrode is a portion other than the short-circuit portion.

5. The electronic watch according to claim 3, wherein
a portion protruding outward from the main plate in the radiation electrode is a portion other than a portion facing the conductive member in the short-circuit portion.

6. The electronic watch according to claim 1, comprising
a casing frame disposed between the case and the main plate, wherein
the casing frame overlaps the radiation electrode in the plan view.

7. The electronic watch according to claim 1, wherein
the printed wired board is formed in a size corresponding to the drive mechanism, and
the power feed member overlaps the main plate and the printed wired board in the plan view.

8. An electronic watch, comprising:
a case;
a hand;
a dial;
a drive mechanism configured to drive the hand;
a main plate to which the drive mechanism is attached;
an antenna disposed between the dial and the main plate in side view when viewed from a direction parallel to a front surface of the dial; and
a printed wired board, wherein
the main plate includes a first region to which the drive mechanism is attached, and a second region that is provided on an outer circumferential side of the first region and abuts on the case,
the antenna includes
a radiation electrode having a plate shape,
a ground electrode having a plate shape, and
a dielectric disposed between the radiation electrode and the ground electrode in the side view,
the printed wired board is conducted to the radiation electrode via a power feed member,
the dial is formed in a size corresponding to the case, and
the radiation electrode includes a portion that overlaps the second region in plan view when viewed from a direction orthogonal to the front surface of the dial.
